(19) United States
(12) Patent Application Publication
(10) Pub. No.: US 2025/0305351 A1
(43) Pub. Date: Oct. 2, 2025

(54) GLAZING COMPRISING INTEGRATED SECONDARY GLAZING PANE

(71) Applicant: Pilkington Group Limited, Lathom (GB)

(72) Inventors: Christoph HAYN, Ratingen (DE); Christian EIBL, Duisburg (DE); Marcel RIBBERINK, Enschede (NL); Bernhard GOER, Recklinghausen (DE)

(21) Appl. No.: 18/864,152

(22) PCT Filed: May 11, 2023
(86) PCT No.: PCT/GB2023/051234

§ 371 Date: Nov. 8, 2024

(30) Foreign Application Priority Data
May 12, 2022 (GB) 2206970.2

(51) Int. Cl. E06B 3/663; E06B 3/67

(52) U.S. Cl. CPC E06B 3/66342; E06B 3/6722

(57) ABSTRACT

A glazing includes an integrated secondary glazing pane and a functional element. The advantage of such an arrangement is that a building aperture may be provided with a variety of functional elements which are not normally compatible with an insulated glazing unit, while still offering the ease of use and efficient manufacturing system of an insulated glazing unit. A method of manufacturing such a glazing is also provided.

The present invention relates to glazings, in particular a glazing comprising an integrated secondary glazing pane, and a method of manufacturing such a glazing.

Glazings are commonly installed into apertures in buildings: such apertures may be in the building envelope or within the building itself. Glazings comprise one or more glazing panes. A common glazing pane for glazings is a glass sheet, however in some cases plastic sheets may be employed. An alternative glazing pane is a laminated pane. Laminated panes typically comprise two or more sheets of glazing material, often glass, adhered together by an interlayer, commonly polyvinyl butyral. Such laminated panes may be employed to improve heat insulating performance, sound insulating performance, and/or intrusion resistance, for example.

In order to further reduce the transmission of heat, a building aperture equipped with a glazing may be provided with a further glazing, known as a “secondary glazing”. For example GB 2543742 B discloses a secondary glazing unit for a sash window. Such secondary glazings are typically installed in the building aperture after the installation of the first “primary” glazing.

In some cases, it would be advantageous to supply the building aperture with functional elements, for example to improve occupant comfort. There remains a need for glazings that may flexibly allow functional elements to be integrated with building apertures in a cost effective and efficient manner.

According to the first aspect of the invention there is provided a glazing comprising:
a first pane comprising a first major face and a second major face;
a second pane comprising a third major face and a fourth major face; and
a first spacer frame suitable for maintaining a first cavity between the second major face and the third major face, wherein the glazing further comprises:
an integrated secondary glazing pane comprising a fifth major face and a sixth major face;
a second spacer frame suitable for maintaining a second cavity between the fourth major face and the fifth major face; and
a functional element within the second cavity, and wherein
the first cavity is hermetically sealed and the second cavity is not hermetically sealed.

The advantage of such an arrangement is that the building aperture may be provided with a variety of functional elements which are not normally compatible with an insulated glazing unit, while still offering the ease of use and efficient manufacturing system of an insulated glazing unit.

As used herein, a cavity is hermetically sealed in that the moisture penetration index I, as measured according to BS EN 1279-2:2018, is less than or equal to 25%, preferably less than or equal to 20%, and/or the gas leakage rate Lᵢ, as measured according to BS EN 1279-3:2018 is less than or equal to 1.20% a⁻¹, preferably less than or equal to 1.0% a⁻¹.

Therefore, preferably the first cavity has a moisture penetration index I, as measured according to BS EN 1279-2:2018, of less than or equal to 25%, preferably less than or equal to 20%, and/or a gas leakage rate Lᵢ, as measured according to BS EN 1279-3:2018, of less than or equal to 1.20% a⁻¹, preferably less than or equal to 1.0% a⁻¹ and the second cavity has a moisture penetration index I, as measured according to BS EN 1279-2:2018, of greater than 20%, preferably greater than 25%, and/or a gas leakage rate Lᵢ, as measured according to BS EN 1279-3:2018, of greater than 1.20% a⁻¹, preferably greater than 1.0% a⁻¹.

Functional elements provide the glazing with useful characteristics. The inventors have discovered that glazings may be produced which comprise a functional element within a cavity which is not hermetically sealed, but surprisingly the glazing may still provide acceptable insulating and aesthetic performance, provided that the glazing comprises a hermetically sealed cavity. In certain embodiments, the secondary glazing pane will improve the insulating, acoustic and/or aesthetic performance.

In some embodiments, glazings may comprise functional elements within the second cavity which are electrical functional elements. Such electrical functional elements may comprise heating coatings, displays, LEDs, transducers, speakers, sensors, variable transmission elements, photovoltaic elements and the like. In particular: displays may include LCD and OLED displays for example; variable transmission elements may include LCD, electrochromic, and suspended particle elements, for example; and photovoltaic elements may include silicon including, cadmium including, or dye including cells, for example. For example WO 2017027407 A1 discloses electrochromic device integrated glazing unit constructions.

In some embodiments the electrical functional element comprises a busbar or contact. The type of busbar or contact is not particularly limited. The busbar or contact may be electrically connected to functional elements using soldered connections, ultrasonic welds, conductive adhesives and the like.

In some cases the functional element may be a biological functional element, such as a plant, algae or living wall. Such biological functional elements may be attached to substrates or scaffolds to secure them within the second cavity.

Preferably the glazing further comprises an electrical connector with a first end within the second cavity and a second end outside the second cavity, preferably the electrical connector comprises a metal foil, flexible circuit board, braided flat cable, ribbon cable, or flat flex cable.

Electrical functional elements often require the supply of electrical energy and/or data from outside the cavity via connections. Such connections are often made using electrical connectors which must pass from inside the cavity to outside. Previous glazings comprising such electrical connectors have attempted to use hermetic seal compatible connectors, such that a long lasting hermetic seal may be produced despite the electrical connector. However, some electrical functional elements require connectors which are not compatible with hermetic seals. In this case it is difficult to form a long lasting hermetic seal. The present invention overcomes these issues through the use of an integrated secondary glazing pane which forms a cavity which is not hermetically sealed. As such, electrical connectors which are not compatible with hermetic seals may be used.

Preferably, the electrical connector is insulated in an area associated with an edge face of the first pane, and/or in an area associated with the periphery of the first face, and/or in an area associated with the periphery of the second face.

Insulated sections of the electrical connector may prevent the electrification of a frame of the glazing and/or spacer frame.

In some embodiments, the electrical connector is adapted to be suitable for contact with an electrical functional element within the cavity of the glazing. Alternatively or in addition, the electrical connector is adapted to be suitable for contact with an electrical functional element associated with the spacer frame of a glazing.

An electrical connector may be adapted to be suitable for contact with an electrical functional element in that it is not insulated in a region intended for connection.

Alternatively, sockets and plugs suitable for mating with an electrical connector may be added to the electrical connector in a region intended for connection.

Preferably, the electrical connector is in direct electrical communication with the electrical functional element. Such direct electrical communication may be achieved by soldering, ultrasonic welds, conductive adhesives and the like.

In some embodiments the electrical connector may comprise a foil, preferably a metal foil. This is of particular benefit when the electrical functional element is a busbar for a heating coating, or a heating coating, and the electrical carrier is required to carry a large amount of energy to drive the heating coating.

Alternatively, the electrical connector may comprise a flexible circuit board, also known as flexible printed circuit (FPC). Such flexible circuit boards may comprise polyimide foil, polyimide-fluoropolymer composite foil, or other flexible polymeric materials. The flexible circuit board comprises one or more conductive traces suitable for carrying electrical energy and/or data, and such traces may comprise copper, silver, gold.

Alternatively, the electrical connector may be a braided flat cable, ribbon cable, or a flat flex cable. These may be flat laminated cables (FLC) or flat extruded cables (FEC).

In some cases, it is desirable for the functional element to be introduced into the second cavity just preceding, or even after, installation of the glazing in the building aperture. In such cases, the glazing and/or spacer frame may be adapted to allow such introduction. The glazing may include hinges to allow access to the second cavity, and/or slots in the spacer frame.

Alternatively, or in addition, the second spacer frame is adapted to allow the flow of gas from inside the second cavity to outside the second cavity and vice versa. The second spacer frame may be adapted to allow the flow of gas by, for example, incorporating valves, openings or passages in the second spacer frame. Adaptions may include apertures, passages, valves or openings in the second spacer frame, and/or holes in the secondary glazing pane. Where the second cavity is adapted, filters may be incorporated to reduce the introduction of dirt and dust into the second cavity.

Such an arrangement is particularly beneficial when the glazing comprises a biological functional element.

Alternatively, or in addition, the functional element may produce heat, and such adaptions may allow warm gas heated by the functional element to be carried away from the functional element and thereby not impair its operation.

Preferably the first cavity comprises argon, nitrogen, krypton or dry air, preferably argon and/or krypton, most preferably argon. A first cavity comprising argon or krypton improves the thermal performance of the first cavity.

Preferably the glazing further comprises a third pane between the first pane and the second pane. Such an arrangement serves to split the first cavity into sub-cavities, which increases the thermal performance of the glazing.

Preferably, the first spacer frame and/or second spacer frame comprises a rigid spacer frame, preferably comprising a hollow rigid spacer or a U-channel rigid spacer, or a flexible spacer frame, preferably comprising a hot applied flexible spacer or a pre-fabricated flexible spacer.

A wide variety of spacer frame bodies known to the person skilled in the art can be used since the solution according to the invention is compatible with any spacers.

In some embodiments the spacer frame may comprise a rigid spacer frame. A rigid spacer frame in general will have enough rigidity to be preassembled prior to application and applied against one pane of the insulating glass before assembly. Preferably the rigid spacer frame comprises a hollow rigid spacer or a U-channel rigid spacer, which may be fully metallic or may comprise polymeric parts.

In some embodiments the spacer comprises a metallic body. This has the advantage that metallic spacers are gas-tight, and no barrier films are needed to seal the outer surface of the spacer. The metallic main body is preferably made of aluminium or stainless steel, particularly preferably aluminium.

Alternatively, the spacer includes a polymeric frame body. This is advantageous since the thermal conductivity of plastics is significantly lower than the thermal conductivity of metals. The polymeric main body preferably contains polyethylene (PE), polycarbonates (PC), polypropylene (PP), polystyrene, polybutadiene, polynitriles, polyesters, polyurethanes, polymethyl methacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof. Particularly good results are achieved with these materials.

Rigid spacers that comprise polymeric parts may contribute to decreased heat loss through the glazing. A suitable spacer with a polymeric main body is disclosed, for example, in WO 2013/104507 A1.

In general, a rigid spacer frame will comprise joint pieces for connecting rigid spacers together to form the frame. A joint piece that connects rigid spacers to form a corner is known as a corner key.

In alternative embodiments, the spacer frame may comprise a flexible spacer frame. Preferably, a flexible spacer frame comprises a hot applied flexible spacer or a pre-fabricated flexible spacer, which are polymeric. A hot applied flexible spacer is commonly extruded directly onto a glass pane at elevated temperature before assembly, while a prefabricated flexible spacer is extruded onto an intermediate surface at ambient or elevated temperature, then applied as a whole frame to the glass pane before assembly. An extruded thermoplastic spacer is disclosed in WO 2015197491 A1.

Often the spacer frame will comprise desiccant. Hollow rigid spacers and U-channel rigid spacers may include a powder desiccant within the hollow or channel, while flexible spacers may include desiccant beads and the like within the spacer material.

In some embodiments, the spacer is a double spacer that can accommodate at least one additional pane in a groove. Such spacers are known from WO 2014/198431 A1, among others.

Preferably the first spacer frame and the second spacer frame are of the same material, preferably the first spacer frame comprises a flexible extruded spacer frame and the second spacer frame comprises a flexible extruded spacer frame.

Where the first and second spacer frames are formed of the same material, this leads to efficient manufacturing.

In some embodiments, the glazing further comprises a secondary sealant, preferably a polyurethane, polysulfide, or silicone secondary sealant, which is suitable for forming a hermetic seal. Such seals are well known to the skilled person. In some cases, the glazing may comprise seals that are combined primary and secondary seals, which also form the spacer frame.

Preferably the first pane comprises glass and/or the second pane and/or the third pane comprises glass and/or the secondary glazing pane comprises glass, preferably soda-lime silica glass of thickness from 1 mm to 25 mm.

Glass is a widely available and useful glazing material. Soda-lime glass may be particularly preferred, due to low cost. Alternatively, alumina-silicate, boro-silicate and aluminium boro-silicate glasses may be used. Glazing panes of a wide range of thicknesses may be employed in the present invention, preferably the panes have a thickness from 0.1 to 25 mm. However, considering weight and rigidity it may be preferred that glazing panes, and in particular glass, are of a thickness from 3 mm to 6 mm.

Preferably the first pane and/or the second pane and/or the third pane and/or the secondary glazing pane is a laminated pane. Such laminated panes comprise adhesive layers.

Adhesive layers may be selected from the group comprising ethylene vinyl acetate (EVA), polyisobutylene, polyvinyl butyral (PVB), polyurethane (PU), cyclo olefin polymers (COP), ultraviolet activates adhesives. However, preferably, the adhesive layer comprises polyvinyl butyral. Polyvinyl butyral (PVB) is a widely available adhesive layer material. The type of polyvinyl butyral is not particularly limited, but where acoustic, bullet or intruder resistance is required polyvinyl butyral layers suitable for such applications may be used.

Preferably, the second cavity has a width between the fourth major face and the fifth major face of from 1 mm to 30 cm. The width of the second cavity is defined by the functional elements to be associated with it.

Preferably, the second pane and/or the secondary glazing pane are provided with a heating coating suitable for preventing the condensation of moisture within the second cavity, preferably the heating coating is within a laminated pane. Condensation is generally not acceptable to consumers, so a combination of a heating coating with a cavity which is not hermetically sealed has the advantage of reducing the incidence of condensation on pane surfaces associated with the second cavity.

The skilled person will appreciate that additional glass layers, adhesive layers, and functional elements may be provided within the glazing.

The one or more sheets of glazing material may comprise coatings, such as low-emissivity, self-cleaning, and infra-red radiation reflection coatings, as known to the skilled person.

According to a second aspect of the present invention, there is provided a method of manufacturing a glazing comprising the steps of:
providing a glazing comprising a first pane comprising a first major face and a second major face, a second pane comprising a third major face and a fourth major face, and a first spacer frame suitable for maintaining a first cavity between the second major face and the third major face wherein the first cavity is hermetically sealed;
providing a second spacer frame and a secondary glazing pane comprising a fifth major face and a sixth major face; and
   bonding the second spacer frame such that the second pane and the secondary glazing pane to form a second cavity between the fourth major face and the fifth major face wherein the second cavity is not hermetically sealed,
   wherein a functional element is within the second cavity or the second spacer frame is adapted for inserting a functional element into the second cavity.

Such a method allows the simple and efficient functionalisation of a preprepared glazing, such as double glazing or triple glazing.

According to a third aspect of the present invention there is the use of a glazing according to the first aspect, preferably wherein the glazing is installed in an aperture of a building envelope.

The skilled person will appreciate that optional features of the first aspect of the present invention may be applied to the second or third aspects of the present invention.

Functional elements may be a coating adhered to the face, or a discrete element optionally adhered to a surface by an adhesive, tape or the like.

The invention will now be described according to the following figures, in which:

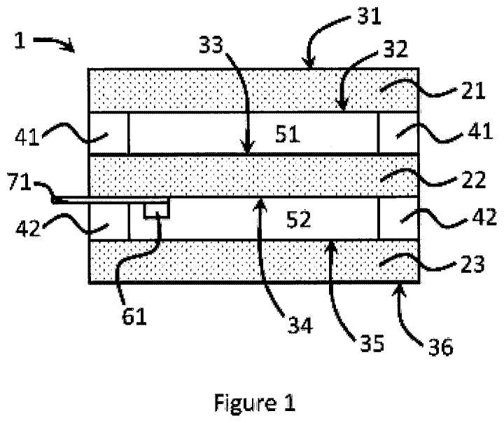

FIG. 1 depicts a glazing 1 according to the present invention; and

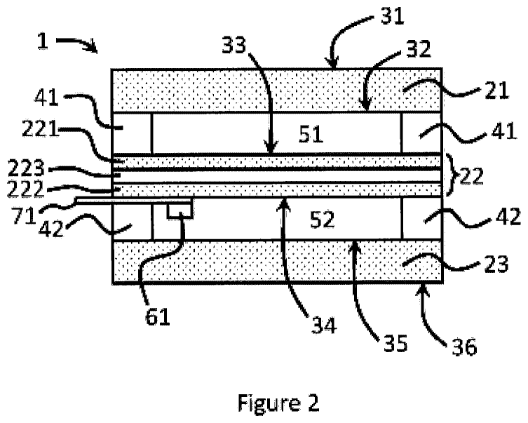

FIG. 2 depicts an alternative glazing 2 according to the present invention.

FIG. 1 depicts a glazing 1 comprising a first pane 21 comprising a first major face 31, a second major face 32 and a second pane 22 comprising a third major face 33 and a fourth 34 major face. A first spacer frame 41 is between the second major face 32 and the third major face 33 and is suitable for maintaining a first cavity 51 therebetween.

The glazing 1 further comprises a secondary glazing pane 23 comprising a fifth major face 35 and a sixth major face 36. A second spacer frame 42 is between the fourth major face 34 and the fifth major face 35 and is suitable for maintaining a second cavity 52 therebetween.

The glazing 1 further comprises a functional element 61 between the second pane 22 and the third pane 23. In this embodiment the functional element 61 is an electrical functional element. A connector 71 is connected to the electrical functional element 61 for supplying power and/or data. The first cavity 51 is hermetically sealed to EN1279 standard and the second cavity 52 is not hermetically sealed to EN1279 standard.

FIG. 2 depicts an alternative glazing 2 according to the present invention. Like features with FIG. 1 have like numbering. In this embodiment, the second pane 2 is a laminated pane, comprising a first sheet of glass 221, a second sheet of glass 222, and an adhesive layer 223 therebetween. The second sheet of glass 222 is between the adhesive layer 223 and the second cavity 52, and is provided with a heating coating (not shown) on the face orientated towards the adhesive layer 222.

In this embodiment the heating coating prevents moisture from condensing within the second cavity 52. Condensation is generally not acceptable to consumers, so a combination of a heating coating with a cavity which is not certified to EN1279 is beneficial.

1.-15. (canceled)

16. A glazing comprising:
a first pane comprising a first major face and a second major face;
a second pane comprising a third major face and a fourth major face; and
a first spacer frame suitable for maintaining a first cavity between the second major face and the third major face,
wherein the glazing further comprises:
an integrated secondary glazing pane comprising a fifth major face and a sixth major face;
a second spacer frame suitable for maintaining a second cavity between the fourth major face and the fifth major face; and
a functional element within the second cavity, and
wherein the first cavity is hermetically sealed and the second cavity is not hermetically sealed.

17. The glazing according to claim 16, wherein the first cavity has a moisture penetration index I, as measured according to BS EN 1279-2:2018, of less than or equal to 25%, optionally less than or equal to 20%, and/or a gas leakage rate Lᵢ, as measured according to BS EN 1279-3:2018, of less than or equal to 1.20% a⁻¹, optionally less than or equal to 1.0% a⁻¹ and the second cavity has a moisture penetration index I, as measured according to BS EN 1279-2:2018, of greater than 20%, preferably greater than 25%, and/or a gas leakage rate Lᵢ, as measured according to BS EN 1279-3:2018, of greater than 1.20% a⁻¹, preferably greater than 1.0% a⁻¹.

18. The glazing according to claim 16, wherein the functional element is an electrical functional element.

19. The glazing according to claim 16, wherein the functional element is a heating coating, display, variable transmission element and/or a photovoltaic element.

20. The glazing according to claim 16, wherein the glazing further comprises an electrical connector with a first end within the second cavity and a second end outside the second cavity.

21. The glazing according to claim 16, wherein the glazing further comprises an electrical connector with a first end within the second cavity and a second end outside the second cavity, wherein the electrical connector comprises a metal foil, flexible circuit board, braided flat cable, ribbon cable, or flat flex cable.

22. The glazing according to claim 16, wherein the second spacer frame is adapted to allow the flow of gas from inside the second cavity to outside the second cavity and/or vice versa.

23. The glazing according to claim 16, wherein the first cavity comprises argon, krypton or dry air, optionally argon and/or krypton.

24. The glazing according to claim 16, wherein the first cavity comprises argon.

25. The glazing according to claim 16, further comprising a third pane between the first pane and the second pane.

26. The glazing according to claim 16, wherein the first spacer frame and/or second spacer frame comprises a rigid spacer frame, optionally comprising a hollow rigid spacer or a U-channel rigid spacer, or a flexible spacer frame, preferably comprising a hot applied flexible spacer or a pre-fabricated flexible spacer.

27. The glazing according to claim 16, wherein the first spacer frame and/or second spacer frame comprises a hot applied flexible spacer or a pre-fabricated flexible spacer.

28. The glazing according to claim 16, wherein the first spacer frame and the second spacer frame are of the same material, optionally wherein the first spacer frame comprises a flexible extruded spacer frame and the second spacer frame comprises a flexible extruded spacer frame.

29. The glazing according to claim 16, wherein the first pane comprises glass and/or the second pane comprises glass and/or the third pane comprises glass and/or the secondary glazing pane comprises glass, preferably soda-lime silica glass of thickness from 1 mm to 25 mm.

30. The glazing according to claim 16, wherein the first pane and/or the second pane and/or the third pane and/or the secondary glazing pane comprises soda-lime silica glass of thickness from 1 mm to 25 mm.

31. The glazing according to claim 16, wherein first pane and/or the second pane and/or the third pane and/or the secondary glazing pane is a laminated pane.

32. The glazing according to claim 16, wherein the second cavity has a width between the fourth major face and the fifth major face of from 1 mm to 30 cm.

33. The glazing according to claim 16, wherein the second pane and/or the third pane are provided with a heating coating suitable for preventing the condensation of moisture within the second cavity, optionally wherein the heating coating is within a laminated pane.

34. A method of manufacturing a glazing according to claim 16, comprising the steps of:
providing a glazing comprising a first pane comprising a first major face and a second major face, a second pane comprising a third major face and a fourth major face, and a first spacer frame suitable for maintaining a first cavity between the second major face and the third major face wherein the first cavity is hermetically sealed;
providing a second spacer frame and a secondary glazing pane comprising a fifth major face and a sixth major face; and
bonding the second spacer frame such that the second pane and the secondary glazing pane to form a second cavity between the fourth major face and the fifth major face wherein the second cavity is not hermetically sealed,
wherein a functional element is within the second cavity or the second spacer frame is adapted for inserting a functional element into the second cavity.

35. A method comprising installing the glazing of claim 16 in an aperture of a building envelope.
